(19) United States
(12) Patent Application Publication
(10) Pub. No.: US 2017/0161756 A1
(43) Pub. Date: Jun. 8, 2017

(54) METHODS, SYSTEMS AND APPARATUS TO IMPROVE BAYESIAN POSTERIOR GENERATION EFFICIENCY

(71) Applicant: The Nielsen Company (US), LLC, New York, NY (US)

(72) Inventors: Michael J. Zenor, Cedar Park, TX (US); John Mansour, North Aurora, IL (US); Mitchel Kriss, Long Grove, IL (US)

(21) Appl. No.: 15/371,725

(22) Filed: Dec. 7, 2016

Related U.S. Application Data
(60) Provisional application No. 62/264,440, filed on Dec. 8, 2015.

(51) Int. Cl. G06Q 30/02

(52) U.S. Cl. CPC G06Q 30/0201; G06Q 30/0204

(57) ABSTRACT

Methods, apparatus, systems and articles of manufacture are disclosed to improve Bayesian posterior generation efficiency. An example apparatus to improve posterior calculation efficiency includes a logit model engine to generate a logit model associated with prior data, the logit model engine to assign initial logit coefficient values to products of interest for respective segments of interest, a penalty engine to improve posterior calculation efficiency by generating penalty modifiers, the penalty modifiers to balance modification of the initial logit coefficient values without merging the prior data with store conditions, and an analysis engine to calculate posterior output values of the prior data by evaluating the initial logit coefficient values with the penalty modifiers via a maximum likelihood estimation, the posterior output values indicative of modifications to the initial logit coefficient values caused by empirical store data sales activity.

### RELATED APPLICATION

This patent claims the benefit of U.S. Provisional Patent Application Ser. No. 62/264,440 filed on Dec. 8, 2015, which is hereby incorporated herein by reference in its entirety.

### FIELD OF THE DISCLOSURE

This disclosure relates generally to consumer modeling, and, more particularly, to methods, systems and apparatus to improve Bayesian posterior generation efficiency.

### BACKGROUND

In recent years, detailed panelist data has been used by market researchers to identify information associated with purchase activity. The panelist data may identify types of consumer segments, while relatively more abundant point-of-sale (POS) data has been used by the market researchers to track sales and estimate price and promotion sensitivity. Although the POS data is relatively more abundant than the panelist data, the POS data does not include segment and/or demographic information associated with the sale information.

### BRIEF DESCRIPTION OF THE DRAWINGS

FIG. 1 is a schematic illustration of an example Bayesian analysis system constructed in accordance with the teachings of this disclosure to improve Bayesian posterior generation efficiency.

FIG. 2 is an example analysis table generated by the example Bayesian analysis system of FIG. 1 to improve Bayesian posterior generation efficiency.

FIGS. 3-6 are flowcharts representative of example machine readable instructions that may be executed to implement the example Bayesian analysis system of FIGS. 1 and/or 2.

FIG. 7 is a block diagram of an example processor platform structured to execute the example machine readable instructions of FIGS. 3-6 to implement the example Bayesian analysis system of FIGS. 1 and/or 2.

### DETAILED DESCRIPTION

Market researchers have traditionally relied upon panelist data and/or U.S. Census Bureau data to determine segment information associated with one or more locations (e.g., trading areas) of interest. Segment information helps to map descriptive segments of consumers (e.g., Hispanic, price sensitive, impulsive purchasers, or other descriptions that may be used to characterize groups of consumers with similar characteristics) to one or more other purchasing categories that may indicate an affinity for certain products, geography, store, brand, etc. Thus, the segment information may provide, for example, an indication that a first percentage of shoppers in a market of interest are Hispanic and a second percentage of the shoppers in a market of interest are non-Hispanic, where the ethnic descriptions may correlate with particular purchasing characteristics.

Armed with segment information and point-of-sale (POS) data, market researchers may multiply the relevant POS data with the fractional segment values corresponding to the demographic segment of interest to determine a decomposition (decomp) of sales of product(s) by segment. For example, POS data includes detailed information associated with sales in each monitored store, and such POS data may include an accurate quantity of products sold per unit of time, a price for which each item was sold and/or whether one or more promotions were present at the store. Such POS data does not, however, typically include information related to demographics and/or segment information related to the consumers that purchased the products/items of interest. Instead, market researchers typically rely on panelist data to reveal details related to consumer demographics. The mathematical product of total sales (e.g., total universal product code (UPC) sales) and the segment percentage of the corresponding location of interest (e.g., a market, a store, a region, a town, a city, a nation, etc.) yields a value indicative of how many units of each of a set of UPCs in the corresponding location are purchased by shoppers associated with each segment.

In some circumstances, the panelist data does not reconcile with the retail sales data. In other words, the abundant and accurate POS data (which is devoid of segment information) identifies values (e.g., dollar amounts, quantities of UPCs sold, etc.) of purchasing behavior, and the associated panelist data (which includes segment information) associated with that same market of interest is inconsistent with the POS data. In view of such discrepancies, one or more techniques may be applied to align the panelist data in a manner that is consistent with the POS data. For example, a Bayesian analysis is applied to anchor the panelist data with the POS data. Generally speaking, a Bayesian analysis traditionally uses one or more starting point data sets, sometimes referred to herein as “priors” (e.g., panelist data indicative of what a portion of the consumers represent (e.g., particular demographics, particular segments, etc.)), to generate a likelihood function to predict a posterior value based on the POS data. The priors represent a starting point of the Bayesian analysis, and represent starting point values associated with segments of interest, relative preferences within segments (e.g., a first product is preferred over a second product), and/or relative sizes of each segment of interest. The posterior value includes a “corrected” or modified representation of the priors. Using the posterior data, decompositions can be calculated in view of actual sales data to identify proportions of the consumers on a segment by segment basis.

The traditional Bayesian analysis introduces substantial computational burdens by, in part, requiring mapping (linking) of the panel data to corresponding POS data (also known as retail measurement sales (RMS) data) for corresponding time periods of interest (e.g., store week). POS/RMS data typically includes a product code, a market code and a time code (e.g., UPC per store per week). When traditional mapping/linking is applied to a Bayesian process, the priors can be modified in an effort to align the starting point estimation with actual empirical store sales data. For example, to allow the Bayesian analysis to generate posteriors capable of estimations for markets of interest, several thousands of panelist data points must be mapped in time, product and/or market to corresponding data points of the POS data. In some examples, the panel data mapping can take days to process, in which iterative verification operations must be performed to identify missing mapping information and/or correct erroneous mapping information. The traditional Bayesian analysis may also fail to adjust modifications and/or corrections of the prior data in a manner that retains one or more valuable insights to the prior data. In some examples, the traditional Bayesian analysis adjusts modeling parameters to align with the POS data without adhering and/or otherwise giving deference to the priors.

However, in some circumstances available panelist data is too low to provide statistically significant coverage of how different segments treat and/or otherwise purchase different products (items) of interest. While panelist data includes thorough demographic information and/or information associated with segments of interest, some panelist data lacks a sufficient degree of coverage to obtain detailed granular data regarding product purchases and their respective segments of interest. For example, in relatively large metropolitan areas (e.g., Chicago), several thousand panelists may be used to generate panelist data regarding UPC purchases and to associate those purchases with segment information. However, the number of candidate UPCs that each panelist could purchase greatly outnumbers available panelists, which may lead to inaccuracies and/or lack of coverage for granular data about which segments purchase which UPCs for a given trading area.

Example methods, apparatus, systems and articles of manufacture disclosed herein generate Bayesian posterior estimations with prior data that does not require rigorous control and/or management that is associated with panelist data. In other words, examples disclosed herein allow Bayesian posterior estimations to occur with any type of prior data, which includes panelist data, non-panelist data, survey data and/or starting point data related to expert judgements (e.g., store manager heuristics, estimations, educated guesses, etc.). Additionally, examples disclosed herein generate Bayesian posterior estimations without computational burdens associated with panel data mapping/linking that is required for traditional Bayesian analysis techniques. Instead, examples disclosed herein employ penalty modifiers to balance modification of iterative estimations of modeling coefficients without any need to merge the prior data (e.g., panelist data) with store-level condition information, thereby improving a computational efficiency when calculating posterior estimations and reducing an amount of time to do the same. Additionally, example disclosed herein generate and/or otherwise calculate Bayesian posterior estimations that balance (a) recovery of observed store sales while (b) adhering as close to possible to prior data via penalty functions, as described in further detail below.

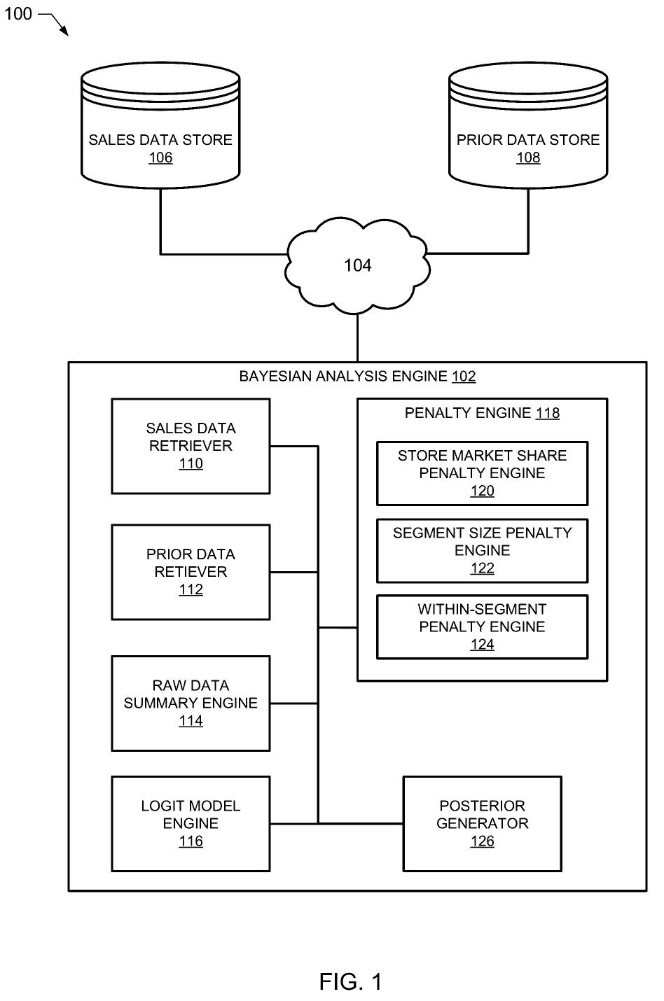

FIG. 1 illustrates an example implementation of an example Bayesian analysis system 100. The Bayesian analysis system 100 of the example of FIG. 1 includes a Bayesian analysis engine 102 that is communicatively connected via one or more networks 104 to an example sales data store 106 and an example prior data store 108. In operation, the example sales data store 106 includes and/or otherwise provides aggregate market sales data for market available products, such as quantities (e.g., in units, in dollars sold, etc.) for particular products (e.g., UPCs) sold in particular market areas (e.g., particular trading areas) during particular time periods (e.g., units/items sold in the last week, units/items sold in the last month, units/items sold in the last quarter, etc.). In some examples, the sales data from the sales data store 106 is obtained and/or otherwise retrieved from retailer POS scanner data. As such, the sales data in the example sales data store 106 is sometimes referred to as “truth data.”

In operation, the example prior data store 108 includes and/or otherwise provides prior data to be used in the Bayesian analysis. While the prior data may include panelist data, examples disclosed herein are not limited to the rigorous quality requirements typically associated with panelist data. Generally speaking, panelist data typically requires a requisite amount of panelist control and volume (e.g., a number of data points associated with one or more demographics/segments of interest) to provide results that are statistically significant. In some instances, marketing budgets and/or marketing computing resources preclude this level of control or volume. As such, examples disclosed herein remove such stringent control requirements for large and robust data samples based on panelists. The prior data stored in the example prior data store 108 may include partial panelist data (e.g., relatively low sample sizes), survey data, empirical observation data (e.g., from a store manager), heuristics and/or educated guesses (e.g., from a store manager, an industry expert, etc.). As discussed above, prior data serves as a starting point when generating posterior data, in which the posterior data is a modified result of the prior data in view of truth data.

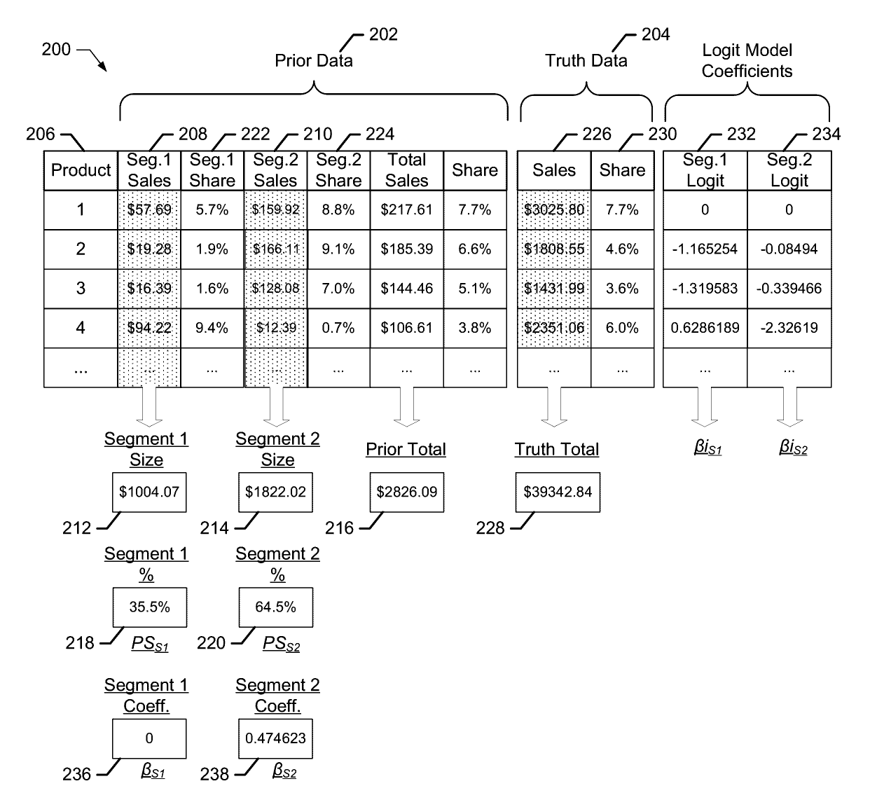

In the illustrated example of FIG. 1, the Bayesian analysis engine 102 includes an example sales data retriever 110, an example prior data retriever 112, an example raw data summary engine 114, an example logit engine 116, an example penalty engine 118, and an example posterior generator 126. The example penalty engine 118 of FIG. 1 includes an example store market share penalty engine 120, an example segment size penalty engine 122, and an example within-segment penalty engine 124. In operation, the example sales data retriever 110 acquires store data from the example sales data store 106 for a time-period of interest (e.g., a store week) for one or more products of interest. As described above, the store data may include item sales data from POS scanners at a retail location of interest for the time-period of interest. The example prior data retriever 112 acquires prior data associated with the one or more products of interest in the store of interest. Portions of the truth data and the prior data are shown in the illustrated example of FIG. 2.

In the illustrated example of FIG. 2, an example analysis table 200 includes example prior data 202 from the example prior data store 108, and example truth data 204 from the example sales data store 106. The example truth data 204 and example prior data 202 are associated with any number of different products, four of which are shown in a product column 206. While the illustrated example of FIG. 2 includes prior data 202 that is associated with a first segment 208 and a second segment 210, examples disclosed herein are not limited thereto. In particular, the example prior data 202 associated with a first segment 208 and a second segment 210 (see shaded columns named “Seg. 1 Sales” and “Seg. 2 Sales” respectively) includes data associated with a dollar amount of sales for each product of interest that, as described above, may be derived from panelist data (e.g., Nielsen Homescan®), survey data, preferred shopping card data, expert educated guesses, etc. The example raw data summary engine 114 calculates corresponding summary data for each of the segments of interest and their associated products. In the illustrated example of FIG. 2, the raw data summary engine 114 calculates a size (in dollars) 212 for the first segment 208 based on a sum of all product sales in that first segment, and calculates a size (in dollars) 214 for the second segment 210 based on a sum of all product sales in that second segment. Additionally, the example raw data summary engine 114 calculates a sum of sales in all segments of interest 216, which is also referred to as the “Prior Total” in the illustrated example of FIG. 2.

Based on the summary data calculated by the example raw data summary engine 114, a corresponding percent share of the first segment 218 (see “Segment 1%” showing a value of 35.5%) and a corresponding percent share of the second segment 220 (see “Segment 2%” showing a value of 64.5%) is also calculated. The example percent share of the first segment 218 and the example percent share of the second segment 220 are sometimes referred to as a first panel segment share (PS_{S1}) and a second panel segment share (PS_{S2}), respectively and as described in further detail below. Generally speaking, the example prior data 202 reflects an expectation that the first segment of interest is responsible for 35.5% of the purchases made in the store of interest (PS_{S1}), and that the second segment of interest is responsible for 64.5% of the purchases made in that store of interest (PS_{S2}).

In addition to calculating segment share values, the example raw data summary engine 114 calculates “within segment shares” of each item of interest. In the illustrated example of FIG. 2, a first segment share column 222 includes share percentage values for each product of interest within a particular segment of interest (e.g., Segment 1). Similarly, a second segment share column 224 includes share percentage values for each product of interest within another particular segment of interest (e.g., Segment 2). As a simple illustration, the example first segment share column 222 includes a value of 5.7%, which was calculated by the raw data summary engine 114 based on the Segment 1 Size total of $1004.07 divided by the sales of Segment 1 for the first product/item value of $57.69. As described in further detail below, values in the first segment share column 222 and the second segment share column 224 are sometimes referred to herein as panel item segment shares (e.g., denoted as Pᵢₛ₁ and Pᵢₛ₂ for the first and second segments of interest, respectively, in which i represents an item/product of interest and s represents a segment of interest).

Although the prior data may not be derived from tightly controlled panelist data and, consequently, include a degree of error, market researchers find substantial value in the predictive nature of prior data. At the same time, while the market researchers acknowledge that the prior data may include this degree of error, examples disclosed herein enable the generation of posterior data that is based on the truth data without overreliance upon (a) the truth data or (b) the prior data in a manner that is more computationally efficient than standard Bayesian analysis techniques. In particular, rather than application of one or more Bayesian analysis techniques that applies too much adherence to the truth data, examples disclosed herein enable an estimation that is balanced between both the (a) truth data and (b) the prior data when generating posterior data.

In the illustrated example of FIG. 2, the example sales data retriever 110 retrieved and/or otherwise received sales data, as shown in the example sales column 226 (shaded). The example raw data summary engine 114 calculates a total sum of sales for each product of interest in the store of interest, which is shown in the illustrated example of FIG. 2 as a truth total 228. For each product of interest, the example raw data summary engine 114 calculates an item share value as shown in an example item share column 230. As a simple illustration, the example share value of 7.7% was calculated by the example raw data summary engine 114 by dividing the sales of the first product ($3025.80) by the total sales of all products ($39,342.84). In some examples, values in the example item share column 230 are referred to herein as retail measurement share (RMS) values and denoted as Rᵢ, in which i reflects a particular item/product of interest.

In view of the above-mentioned prior data 202 and truth data 204, consumerization refers to the application of posterior data and observed sales data to generate one or more estimates of which segments are responsible for the observed sales. Traditional techniques to accomplish consumerization require panelist data that must be mapped to corresponding store weeks before accurate modeling can occur. For instance, an example set of panelist-level choice information is shown in the illustrated example of Table 1.

TABLE 1

| Panelist | Segment | Item | Date | Location |
|---|---|---|---|---|
| 1234 | A | 1 | Jun. 5, 2016 | Walmart |
| 1234 | A | 5 | Jun. 14, 2016 | Kroger |
| 1235 | B | 3 | Jun. 6, 2016 | Safeway |
| . . . | . . . | . . . | . . . | . . . |

In the illustrated example of Table 1, two separate panelists are shown (e.g., a first panelist “1234” and a second panelist “1235”), in which the first panelist is associated with segment “A” (e.g., a segment associated with young, city dwellers) and the second panelist is associated with segment “B” (e.g., a segment associated with middle aged city dwellers). The illustrated example of Table 1 also indicates which items (products) are purchased on particular dates and in particular locations.

An example manner of consumerizing the panel data of the illustrated example of Table 1 includes applying observed percentages to store sales data. Continuing with the example above, assume that segment “A” is responsible for 30% of purchases of product 1 at Walmart, and that segment “B” is responsible for 70% of purchases of product 1 at Walmart. Thus, in the event that one-thousand sales of item 1 occur at Walmart in a first week, then a straightforward projection would apply 30%/70% of those one-thousand units to segments “A” and “B,” respectively. However, in the event the panel data is too small to permit a projection that aligns with statistical expectations, the panelist data must be mapped and/or otherwise linked to the store data (e.g., mapped to store conditions). In such circumstances, a model is developed to apply segment mixtures as a function of one or more store conditions, which is computationally intensive. For example, for all the panelist data, one or more store level conditions must be identified and correctly mapped to the panelist data.

In the illustrated example of Table 2, the panelist data of example Table 1 is shown with example appended store and time information (mapped data).

TABLE 2

| Panelist | Seg | Item | Date | Location | Mapped Data |
|---|---|---|---|---|---|
| 1234 | A | 1 | Jun. 5, 2016 | Walmart | Promotion, weather, |
| | | | | | etc. for Walmart on |
| | | | | | Jun. 5, 2016. |
| 1234 | A | 5 | Jun. 14, 2016 | Kroger | Promotion, weather, |
| | | | | | etc. for Kroger on |
| | | | | | Jun. 14, 2016. |
| 1235 | B | 3 | Jun. 6, 2016 | Safeway | Promotion, weather, |
| | | | | | etc. for Safeway on |
| | | | | | Jun. 6, 2016. |
| . . . | . . . | . . . | . . . | . . . | . . . |

In the illustrated example of Table 2, every panelist datapoint is mapped to the store sales data, which is computationally burdensome. For example, Nielsen Homescan data may include several million panel observations that must be mapped to their corresponding store and/or time-period condition observations before a model can be built. As described in further detail below, examples disclosed herein obviate the need for panelist data mapping when performing consumerization, Bayesian analysis and/or posterior data generation.

The example logit model engine 116 builds a logit model by assigning initial logit coefficients for each segment of interest and product of interest. The illustrated example of FIG. 2 includes a first segment logit coefficient column 232 (“Seg. 1 Logit”) and a second segment logit coefficient column 234 (“Seg. 2 Logit”), in which each coefficient value is referred to as an item-segment coefficient and denoted as β_{iS}, where i reflects a particular item/product of interest and S reflects a particular segment of interest. Additionally, the example logit model engine 116 generates a coefficient value for the first segment of interest (β_{S1}) 236 and a coefficient value for the second segment of interest (β_{S2}) 238. In some examples, the initial logit coefficient values may be selected in any number of ways, such as a random selection, or by selecting a reference product of interest (e.g., set at zero) from which remaining products of interest are assigned coefficient values in proportion to the prior data. As described in further detail below, the example coefficients will be used in connection with the penalty engine 118 (which includes the example store market share penalty engine 120, the example segment size penalty engine 122 and the example within-segment penalty engine 124) during an iterative maximization likelihood estimation (MLE) that adjusts the coefficients. Generally speaking, the MLE in connection with the example penalty engine 118 causes the coefficient values to converge, and the coefficient values allow translation of posterior share values (e.g., predicted share values that are corrected as compared to the starting prior data). As described above, the penalty engine 118 allows calculation of posterior data in a manner that establishes a balanced mixture of trying to fit to the store data as closely as possible, while trying to adhere to the prior data as close as possible.

After the logit model has been generated by the example logit model engine 116, the example penalty engine 118 invokes the example store market share penalty engine 120 to build a store market share penalty. Generally speaking, prior data can deviate from actual truth data (e.g., POS store sales data) in three ways. Either (a) the product/item preferences are different, (b) the segments are different, or (c) the sizes of the segments are different. Accordingly, the example penalty engine 118 generates and applies three different penalties, a first of which considers an effect of the prior data deviating from store market share data. In other words, when the prior data deviates from empirical “truth” data 204, the example store market share penalty engine 120 applies a corresponding penalty value. However, examples disclosed herein do not address deviations from the empirical truth data 204 alone, but also consider whether estimated segment sizes of the prior data deviate from the truth data 204. If so, the example segment size penalty engine 122 builds and applies a second penalty (e.g., a segment size penalty) to the MLE process to more closely adhere coefficient modifications to the prior data 202. Additionally, examples disclosed herein also consider whether prior data 202 associated with estimated shares of a product of interest within each segment of interest deviate from the truth data 204. If so, the example within-segment penalty engine 124 builds and applies a third penalty (e.g., a within-segment penalty) to the MLE process to more closely adhere coefficient modifications to the prior data 202.

Taken together, the example penalty engine 118 develops an objective function of three separate penalties as log likelihood functions, the sum of which is maximized with respect to the logit coefficients during the MLE process. In operation, the example store market share penalty engine 120 selects an item of interest and a segment of interest and calculates an item ratio in a manner consistent with example Expression 1.

$$\begin{matrix}Item Ratio & \\ \frac{{e}^{{β}_{iS}}}{{\sum }_{i} {e}^{{β}_{iS} }} & Expression 1\end{matrix}$$

In the illustrated example of Expression 1, β_{iS} represents an item-segment coefficient associated with respective items (i) and the selected segment (S) of interest, such as the example item-segment coefficients shown in the example first segment logit coefficient column 232 and the example second segment logit coefficient column 234 of the illustrated example of FIG. 2. The example store market share penalty engine 120 calculates a segment ratio in a manner consistent with example Expression 2.

$$\begin{matrix}Segment Ratio & \\ \frac{{e}^{{β}_{S}}}{{\sum }_{S} {e}^{{β}_{S}}} & Expession 2\end{matrix}$$

In the illustrated example of Expression 2, β_{S} represents the segment ratio associated with the selected segment (S) of interest, such as the example coefficient value for the first segment of interest (β_{S1}) 236 and the example coefficient value for the second segment of interest (β_{S2}) 238 of the illustrated example of FIG. 2.

The example store market share penalty engine 120 calculates the mathematical product of the example item ratio (Expression 1) and the example segment ratio (Expression 2) in an iterative manner for each segment of interest. When all segments of interest have been calculated, their sum is multiplied with the truth data item share associated with the selected item/product of interest (e.g., a respective RMS item share in column 230 of FIG. 2). The example store market share penalty engine 120 now selects an alternate item of interest and repeats the above calculations until all items of interest have been considered. Generally speaking, the above identified calculations performed by the example market share penalty engine 120 occur in a manner consistent with example Equation 1.

$${LL}_{STORE} = {\sum }_{i} {R}_{i} * LN [ {\sum }_{S} ( \frac{{e}^{{β}_{iS}}}{{\sum }_{i} {e}^{{β}_{iS}}} ) * ( \frac{{e}^{{β}_{S}}}{{\sum }_{S} {e}^{{β}_{S}}} ) ] . \qquad Equation 1$$

In the illustrated example of Equation 1, LL_{STORE} is the log likelihood store penalty value that is calculated by the example store market share penalty engine 120 as a function of the example item ratio and the example segment ratio. As described above, the example log likelihood store penalty value is one of three penalties that are summed and maximized with respect to the example prior data coefficients.

A second of three penalties is built and applied by the example segment size penalty engine 122. In particular, the example prior data 202 may not be numerically consistent with the example truth data 204 in terms of how large (or small) each segment of interest is believed to be. In the illustrated example of FIG. 2, the example first segment 218 accounts for 35.5% of the purchase activity, while the example second segment 220 accounts for 64.5% of the purchase activity. To the extent that these prior values are inconsistent with the truth data, the example segment size penalty engine 122 generates a penalty function (LL_{SEGMENT}) to balance the possible discrepancies. In operation, the example segment size penalty engine 122 selects a segment of interest and calculates a segment ratio in a manner consistent with example Expression 2 discussed above. For each segment of interest, the example segment size penalty engine 122 multiplies the natural log of the segment ratio with a share value of the segment of interest associated with the example prior data 202 (e.g., such as PS_{S1} 218 or PS_{S2} 220 in the illustrated example of FIG. 2). Accordingly, the sum of these mathematical products across all segments of interest yields a segment size penalty value. Generally speaking, the above identified calculations performed by the example segment size penalty engine 122 occur in a manner consistent with example Equation 2.

$${LL}_{SEGMENT} = {\sum }_{s} {PS}_{S} * LN [ \frac{{e}^{{β}_{S}}}{{\sum }_{S} {e}^{{β}_{S}}} ] . \qquad Equation 2$$

In the illustrated example of Equation 2, LL_{SEGMENT} is the log likelihood segment penalty value that is calculated by the example segment size penalty engine 122 as a function of the example segment ratio and the prior data 202 segment size.

A third of three penalties is built and applied by the example within-segment penalty engine 124. In particular, the example within-segment share values (see column 222 and/or 224 in the illustrated example of FIG. 2) may be inconsistent with the example truth data 204 in terms of how large (or small) a product of interest is represented within a share of interest. To the extent that these prior values are inconsistent with the truth data 204, the example within-segment penalty engine 124 generates a penalty function (LL_{WSEG}) to balance the possible discrepancies. In operation, the example within-segment penalty engine 124 selects an item of interest and, for each segment of interest, calculates an item ratio in a manner consistent with example Expression 1. Additionally, the example within-segment penalty engine 124 multiplies the natural log of the item ratio with respective ones of item share values from the prior data 202 (see example columns 222 and 224). When all segments of interest for a selected item of interest have been evaluated, the example within-segment penalty engine 124 selects another item of interest to calculate in a similar manner. The sum of all items having corresponding segments yields the example within-segment log likelihood penalty value (LL_{WSEG}), which is built and/or otherwise calculated in a manner consistent with example Equation 3.

$${LL}_{WSEG} = {\sum }_{i} {\sum }_{S} {P}_{iS} * LN [ \frac{{e}^{{β}_{iS}}}{{\sum }_{i} {e}^{{β}_{iS}}} ] . \qquad Equation 3$$

In the illustrated example of Equation 3, LL_{WSEG} is the log likelihood within-segment penalty value for the items of interest, and is calculated by the example within-segment penalty engine 124 as a function of the example item ratio and the individualized panel item segment share values.

The example Bayesian analysis engine 102 initiates a Bayesian optimization using MLE to maximize a sum of penalties in connection with the logit coefficients. In particular, the example Bayesian analysis engine 102 maximizes the sum of penalties in a manner consistent with example Equation 4.

LL_{TOTAL}=LL_{STORE}+LL_{SEGMENT}+LL_{WSEG} Equation 4.

In the illustrated example of Equation 4, LL_{TOTAL} is the sum of example Equation 1, Equation 2 and Equation 3. As the example Bayesian analysis engine 102 iterates the MLE, successive iterations of the example logit model item coefficients for each segment of interest (see columns 232 and 234 of FIG. 2) and the segment coefficients β_{S1} 236 and β_{S2} 238 converge in a balanced manner due to the penalties built by the example penalty engine 118. The example posterior generator 126 uses the modified coefficient values in connection with truth data 204 values to generate a Bayesian posterior output of decomposed aggregate store sales associated with the segments of interest (e.g., consumerization).

While an example manner of implementing the Bayesian analysis system 100 of FIG. 1 is illustrated in FIGS. 1 and 2, one or more of the elements, processes and/or devices illustrated in FIGS. 1 and/or 2 may be combined, divided, re-arranged, omitted, eliminated and/or implemented in any other way. Further, the example sales data store 106, the example prior data store 108, the example sales data retriever 110, the example prior data retriever 112, the example raw data summary engine 114, the example logit model engine 116, the example penalty engine 118, the example store market share penalty engine 120, the example segment size penalty engine 122, the example within-segment penalty engine 124, the example posterior generator 126, the example Bayesian analysis engine 102 and/or, more generally, the example Bayesian analysis system 100 of FIG. 1 may be implemented by hardware, software, firmware and/or any combination of hardware, software and/or firmware. Thus, for example, any of the example sales data store 106, the example prior data store 108, the example sales data retriever 110, the example prior data retriever 112, the example raw data summary engine 114, the example logit model engine 116, the example penalty engine 118, the example store market share penalty engine 120, the example segment size penalty engine 122, the example within-segment penalty engine 124, the example posterior generator 126, the example Bayesian analysis engine 102 and/or, more generally, the example Bayesian analysis system 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example sales data store 106, the example prior data store 108, the example sales data retriever 110, the example prior data retriever 112, the example raw data summary engine 114, the example logit model engine 116, the example penalty engine 118, the example store market share penalty engine 120, the example segment size penalty engine 122, the example within-segment penalty engine 124, the example posterior generator 126, the example Bayesian analysis engine 102 and/or, more generally, the example Bayesian analysis system 100 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example Bayesian analysis system 100 of FIG. 1 may include one or more elements, processes and/or devices in addition to, or instead of, those illustrated in FIGS. 1 and/or 2, and/or may include more than one of any or all of the illustrated elements, processes and devices.

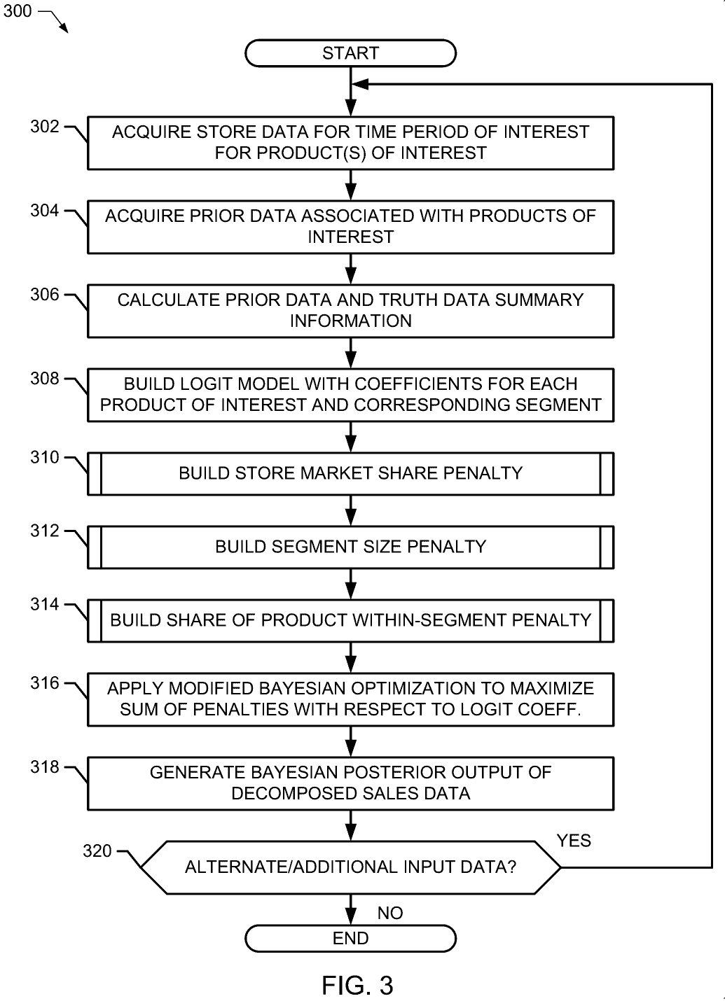

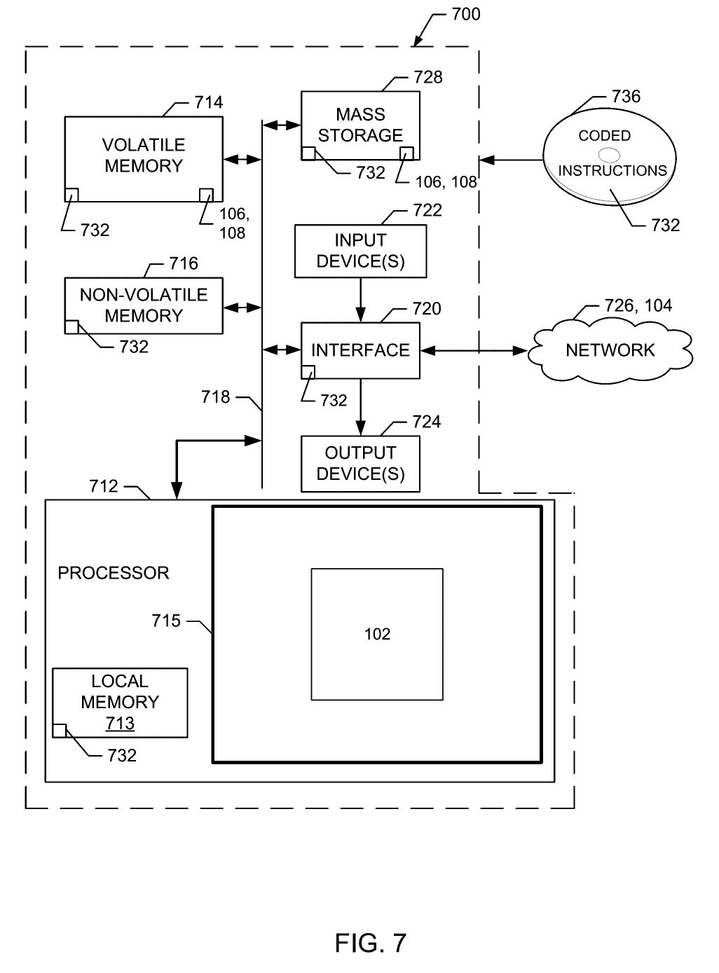

Flowcharts representative of example machine readable instructions for implementing the Bayesian analysis system 100 of FIGS. 1 and 2 are shown in FIGS. 3-6. In these examples, the machine readable instructions comprise a program for execution by a processor such as the processor 712 shown in the example processor platform 700 discussed below in connection with FIG. 7. The program(s) may be embodied in software stored on a tangible computer readable storage medium such as a CD-ROM, a floppy disk, a hard drive, a digital versatile disk (DVD), a Blu-ray disk, or a memory associated with the processor 712, but the entire program(s) and/or parts thereof could alternatively be executed by a device other than the processor 712 and/or embodied in firmware or dedicated hardware. Further, although the example program(s) is/are described with reference to the flowcharts illustrated in FIGS. 3-6, many other methods of implementing the example Bayesian analysis system 100 may alternatively be used. For example, the order of execution of the blocks may be changed, and/or some of the blocks described may be changed, eliminated, or combined.

As mentioned above, the example processes of FIGS. 3-6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 3-6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 300 of FIG. 3 begins at block 302 where the example sales data retriever 110 acquires store data from the example sales data store 106 for a time-period of interest (e.g., a store week) for one or more products of interest. The example prior data retriever 112 acquires prior data from the example prior data store 108 that is associated with one or more products of interest in the store of interest (block 304). The example raw data summary engine 114 calculates one or more aspects of the example prior data 202 and/or the truth data 204 (block 306) such as, but not limited to, a size for the example first segment and the second segment (see items 212 and 214, respectively, in the illustrated example of FIG. 2), per-item segment shares associated with the first segment and the second segment (see items 222 and 224 in the illustrated example of FIG. 2), total segment share values (e.g., see PS_{S1} 218 and PS_{S2} 220), a prior total value (see item 216), a truth total value (see item 228), and/or respective share values for each item associated with the example truth data (e.g., see column 230).

The example logit model engine 116 builds a logit model with respective coefficients for each product and segment combination (block 308). Example coefficient values may be initialized by the example logit model engine 116 in any number of ways, as those coefficient values (e.g., see columns 232 and 234, and β_{S1} and β_{S2} in the illustrated example of FIG. 2) iteratively converge based on a balancing influence of the penalty functions during an MLE. The example penalty engine 118 builds three penalty functions. In particular, the example penalty engine 118 invokes the example store market share penalty engine 120 to build a store market share penalty (block 310), invokes the example segment size penalty engine 122 to build a segment size penalty (block 312), and invokes the example within-segment penalty engine 124 to build a share of product within segments penalty value (block 314), as described above and in further detail below.

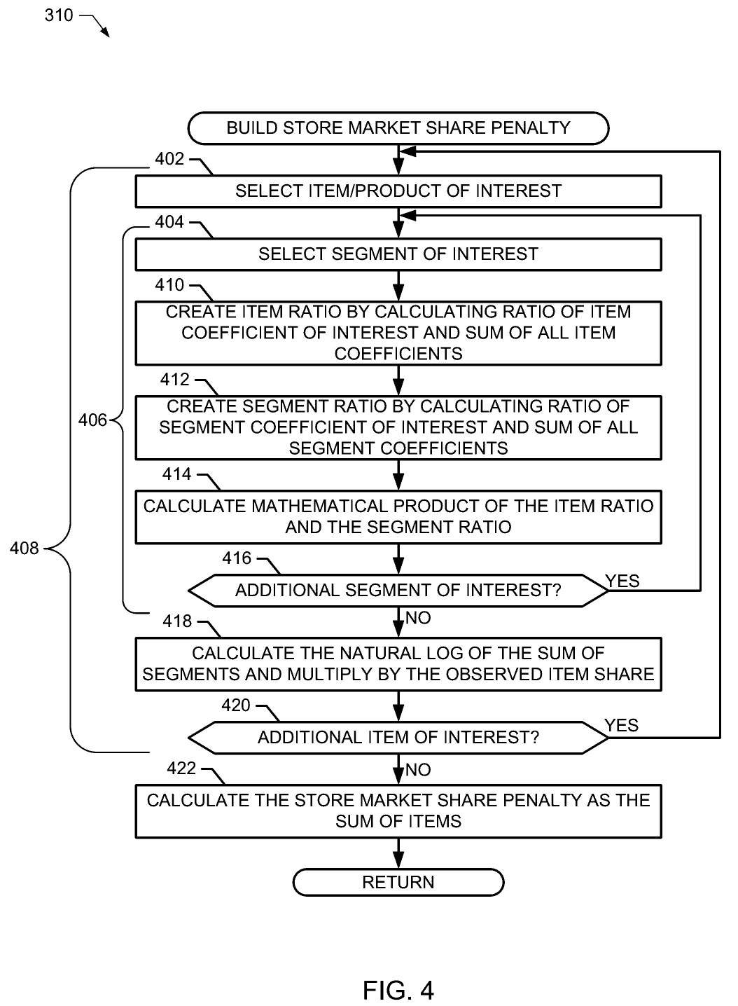

FIG. 4 illustrates additional detail of example block 310 of FIG. 3 in connection with building store market share penalty values. In the illustrated example of FIG. 4, the example store market share penalty engine 120 selects an item of interest (block 402) and a segment of interest (block 404). In particular, the selection of the segment of interest (block 404) initiates a first nested loop (item 406), and the selection of the item of interest (block 402) initiates a second nested loop (item 408). Within the first nested loop (item 406), the example store market share penalty engine 120 creates and/or otherwise calculates an item ratio by calculating a ratio of (a) the selected item coefficient associated with the segment of interest and (b) the sum of all item coefficients for the segment of interest (block 410). As described above, the example item ratio may be calculated in a manner consistent with example Expression 1. The example store market share penalty engine 120 also creates and/or otherwise calculates a segment ratio by calculating a ratio of (a) the coefficient associated with the selected segment of interest and (b) a sum of all coefficients for all segments (block 412). As described above, the example segment ratio may be calculated in a manner consistent with example Expression 2.

The example market share penalty engine 120 calculates the mathematical product of the item ratio and the segment ratio (block 414) and determines if one or more additional segments of interest should be considered (block 416). If so, then the example first nested loop (item 406) iterates and control returns to block 404. On the other hand, if all segments of interest have been considered in connection with the item of interest (block 416), then the example store market share penalty engine 120 calculates the natural log of the sum of segments and multiplies it by an observed item share within the store of interest (block 418). In the event one or more additional items of interest are to be considered (block 420), then the example second nested loop (item 408) iterates and control returns to block 402. If all items of interest have been considered (block 420), then the example store market share penalty engine 120 calculates the store market share penalty value (LL_{STORE}) as the sum of items through the one or more iterations of the example second nested loop (item 408). As described above, the aforementioned calculations by the example store market share penalty engine 120 may occur in a manner consistent with example Equation 1.

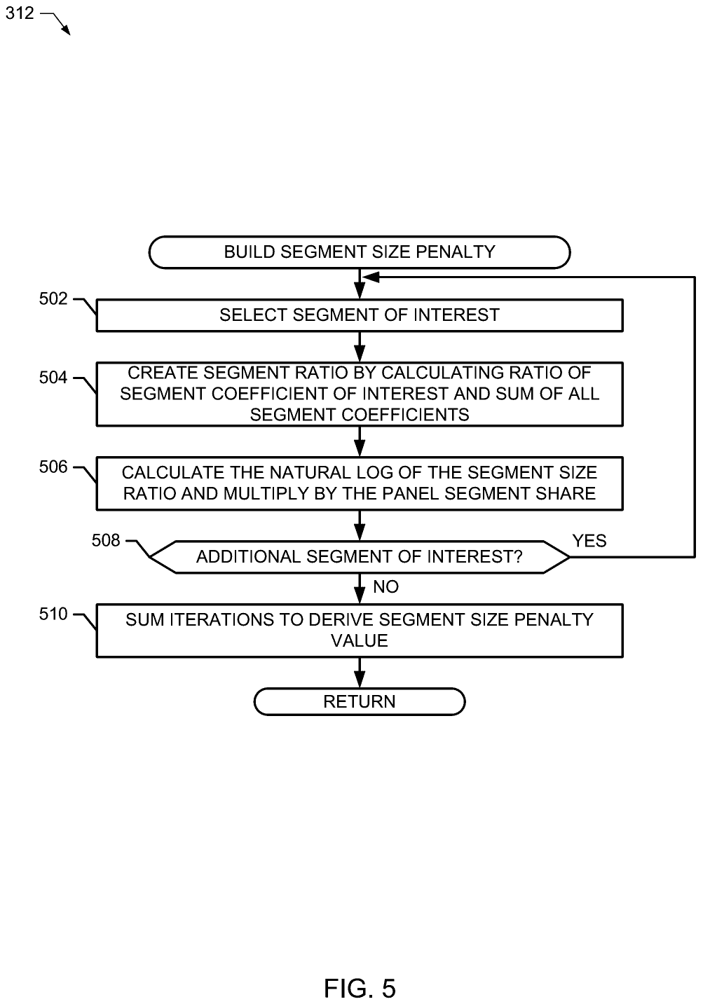

FIG. 5 illustrates additional detail of example block 312 of FIG. 3 in connection with building segment size penalty values. In the illustrated example of FIG. 5, the example segment size penalty engine 122 selects a segment of interest (block 502), and builds and/or otherwise generates a segment ratio in a manner consistent with example Expression 2. In particular, the example segment size penalty engine 122 calculates the segment ratio by calculating a ratio of (a) the selected segment of interest coefficient value and (b) a sum of all segment coefficient values (block 504). The example segment size penalty engine 122 calculates the natural log of the segment size ratio, and multiplies that by a panel segment share value associated with the selected segment of interest (block 506). In the event the example segment size penalty engine 122 determines that additional segments of interest are to be evaluated (block 508), then control returns to block 502 for another iteration of the example program 312. On the other hand, if no further segments of interest are to be evaluated (block 508), the example segment size penalty engine 122 calculates the sum of all iterations to derive the segment size penalty value (LL_{SEG}) (block 510). As described above, the aforementioned calculations by the example segment size penalty engine 122 may occur in a manner consistent with example Equation 2.

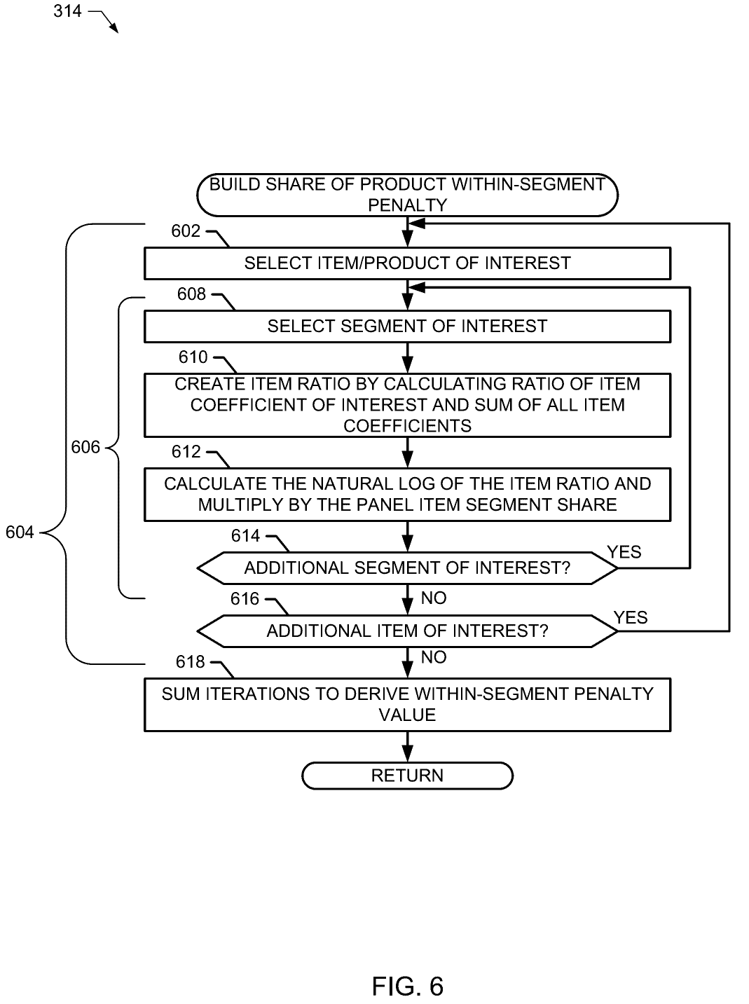

FIG. 6 illustrates additional detail of example block 314 of FIG. 3 in connection with building share of product/item within-segment penalty values. In the illustrated example of FIG. 6, the example within-segment penalty engine 124 selects an item (product) of interest (block 602) to create a first nested loop (item 604), and selects a segment of interest (block 608) to create a second nested loop (item 606). During iterations of the example second nested loop (item 606), the example within-segment penalty engine 124 creates an item ratio in a manner as described above and consistent with example Expression 1 (block 610), and calculates the natural log of the item ratio multiplied by the panel item segment share (block 612). In the event one or more additional segments of interest are to be considered (block 614), the example second nested loop (item 606) iterates and control returns to block 608. Otherwise, the example within-segment penalty engine 124 determines whether one or more items of interest are to be evaluated (block 616). If so, then the example first nested loop (item 604) iterates and control returns to block 602. If not, the example within-segment penalty engine 124 calculates the sum of iterations from the example first nested loop (item 604) and the example second nested loop (item 606) to derive the example within-segment penalty value (block 618).

Returning to the illustrated example program 300 of FIG. 3, the example Bayesian analysis engine 102 applies and/or otherwise initiates a modified Bayesian optimization using, for example, MLE to maximize the sum of penalties (e.g., see example Equation 4) with respect to the logit model coefficients (block 316). As described above, iterations of the modified Bayesian process and MLE cause the logit model coefficients to converge to optimized values that balance competing influences of (a) the prior data 202 and (b) the truth data 204 in a manner that obviates any need to map the prior data 202 to the truth data 204. Accordingly, Bayesian posterior data can be generated and/or otherwise calculated in a more efficient and less computationally intensive manner as compared to traditional Bayesian techniques. The example posterior generator 126 uses the modified coefficient values in connection with the example truth data values 204 to generate the Bayesian posterior output(s) of decomposed aggregate store sales associated with the segments of interest (block 318). In the event new and/or alternate prior data is available (e.g., after another store week), and/or in the event new and/or updated truth data is retrieved and/or otherwise obtained (block 320), the example Bayesian analysis engine 102 directs program 300 flow back to block 302.

FIG. 7 is a block diagram of an example processor platform 700 capable of executing the instructions of FIGS. 3-6 to implement the Bayesian analysis system 100 of FIGS. 1 and 2. The processor platform 700 can be, for example, a server, a personal computer, a mobile device (e.g., a cell phone, a smart phone, a tablet such as an iPad™), an Internet appliance, a set top box, or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer. In the illustrated example of FIG. 7, the processor 700 includes one or more example processing cores 715 configured via example instructions 732, which include the example instructions of FIGS. 3-6 to implement the example Bayesian analysis system 100 of FIGS. 1 and 2.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

The coded instructions 732 of FIGS. 3-6 may be stored in the mass storage device 728, in the volatile memory 714, in the non-volatile memory 716, and/or on a removable tangible computer readable storage medium such as a CD or DVD.

From the foregoing, it will be appreciated that the above disclosed methods, apparatus, systems and articles of manufacture enable the generation of posterior data that is based on the truth data without overreliance upon (a) the truth data or (b) the prior data in a manner that is more computationally efficient than standard Bayesian analysis techniques. In particular, rather than application of one or more Bayesian analysis techniques that applies too much adherence to the truth data, examples disclosed herein enable an estimation that is balanced between both the (a) truth data and (b) the prior data when generating posterior data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus to improve posterior calculation efficiency, comprising:
a logit model engine to generate a logit model associated with prior data, the logit model engine to assign initial logit coefficient values to products of interest for respective segments of interest;
a penalty engine to improve posterior calculation efficiency by generating penalty modifiers, the penalty modifiers to balance modification of the initial logit coefficient values without merging the prior data with store conditions; and
an analysis engine to calculate posterior output values of the prior data by evaluating the initial logit coefficient values with the penalty modifiers via a maximum likelihood estimation, the posterior output values indicative of modifications to the initial logit coefficient values caused by empirical store data sales activity.

2. The apparatus as defined in claim 1, further including:
a market share penalty engine to calculate a first one of the penalty modifiers as a market share penalty;
a segment size penalty engine to calculate a second one of the penalty modifiers as a segment size penalty; and
a within-segment penalty engine to calculate a third one of the penalty modifiers as a within-segment penalty.

3. The apparatus as defined in claim 2, wherein the analysis engine is to apply the penalty modifiers as a maximized sum of the first one of the penalty modifiers, the second one of the penalty modifiers, and the third one of the penalty modifiers.

4. The apparatus as defined in claim 1, further including a raw data summary engine to calculate an observed item share value based on a sum of respective ones of the products of interest from the empirical store data sales activity.

5. The apparatus as defined in claim 4, further including a market share penalty engine to calculate a market share penalty based on the observed item share, an item ratio of respective first ones of the initial logit coefficients, and a segment ratio of respective second ones of the initial logit coefficients.

6. The apparatus as defined in claim 5, wherein the market share penalty engine is to calculate the item ratio as a ratio of (a) respective ones of coefficients of the products of interest and (b) a sum of all coefficients of the products of interest.

7. The apparatus as defined in claim 5, wherein the market share penalty engine is to calculate the segment ratio as a ratio of (a) respective ones of coefficients of the segments of interest and (b) a sum of all coefficients of the segments of interest.

8. A computer-implemented method to improve posterior calculation efficiency, the method comprising:
generating, by executing an instruction with a processor, a logit model associated with prior data, the logit model engine to assign initial logit coefficient values to products of interest for respective segments of interest;
improving, by executing an instruction with the processor, posterior calculation efficiency by generating penalty modifiers, the penalty modifiers to balance modification of the initial logit coefficient values without merging the prior data with store conditions; and
calculating, by executing an instruction with the processor, posterior output values of the prior data by evaluating the initial logit coefficient values with the penalty modifiers via a maximum likelihood estimation, the posterior output values indicative of modifications to the initial logit coefficient values caused by empirical store data sales activity.

9. The computer-implemented method as defined in claim 8, further including:
calculating a first one of the penalty modifiers as a market share penalty;
calculating a second one of the penalty modifiers as a segment size penalty; and
calculating a third one of the penalty modifiers as a within-segment penalty.

10. The computer-implemented method as defined in claim 9, further including applying the penalty modifiers as a maximized sum of the first one of the penalty modifiers, the second one of the penalty modifiers, and the third one of the penalty modifiers.

11. The computer-implemented method as defined in claim 8, further including calculating an observed item share value based on a sum of respective ones of the products of interest from the empirical store data sales activity.

12. The computer-implemented method as defined in claim 11, further including calculating a market share penalty based on the observed item share, an item ratio of respective first ones of the initial logit coefficients, and a segment ratio of respective second ones of the initial logit coefficients.

13. The computer-implemented method as defined in claim 12, further including calculating the item ratio as a ratio of (a) respective ones of coefficients of the products of interest and (b) a sum of all coefficients of the products of interest.

14. The computer-implemented method as defined in claim 12, further including calculating the segment ratio as a ratio of (a) respective ones of coefficients of the segments of interest and (b) a sum of all coefficients of the segments of interest.

15. A tangible computer readable storage medium comprising instructions that, when executed, cause a processor to, at least:
generate a logit model associated with prior data, the logit model engine to assign initial logit coefficient values to products of interest for respective segments of interest;
improve posterior calculation efficiency by generating penalty modifiers, the penalty modifiers to balance modification of the initial logit coefficient values without merging the prior data with store conditions; and
calculate posterior output values of the prior data by evaluating the initial logit coefficient values with the penalty modifiers via a maximum likelihood estimation, the posterior output values indicative of modifications to the initial logit coefficient values caused by empirical store data sales activity.

16. The tangible computer readable storage medium as defined in claim 15, wherein the instructions, when executed, cause the processor to:
calculate a first one of the penalty modifiers as a market share penalty;
calculate a second one of the penalty modifiers as a segment size penalty; and
calculate a third one of the penalty modifiers as a within-segment penalty.

17. The tangible computer readable storage medium as defined in claim 16, wherein the instructions, when executed, cause the processor to apply the penalty modifiers as a maximized sum of the first one of the penalty modifiers, the second one of the penalty modifiers, and the third one of the penalty modifiers.

18. The tangible computer readable storage medium as defined in claim 15, wherein the instructions, when executed, cause the processor to calculate an observed item share value based on a sum of respective ones of the products of interest from the empirical store data sales activity.

19. The tangible computer readable storage medium as defined in claim 18, wherein the instructions, when executed, cause the processor to calculate a market share penalty based on the observed item share, an item ratio of respective first ones of the initial logit coefficients, and a segment ratio of respective second ones of the initial logit coefficients.

20. The tangible computer readable storage medium as defined in claim 19, wherein the instructions, when executed, cause the processor to calculate the item ratio as a ratio of (a) respective ones of coefficients of the products of interest and (b) a sum of all coefficients of the products of interest.
